(19) United States
(12) Patent Application Publication
(10) Pub. No.: US 2024/0002989 A1
(43) Pub. Date: Jan. 4, 2024

(54) PRESSING TOOL AND METHOD FOR PRODUCING A PRESSING TOOL

(71) Applicant: HUECK Rheinische GmbH, Viersen (DE)

(72) Inventors: Thorsten HAGEDORN, Viersen (DE); Berthold THÖLEN, Viersen (DE)

(73) Assignee: HUECK Rheinische GmbH, Viersen (DE)

(21) Appl. No.: 17/769,205

(22) PCT Filed: Oct. 12, 2020
(86) PCT No.: PCT/EP20/78581

§ 371 Date: Apr. 14, 2022

(30) Foreign Application Priority Data
Oct. 15, 2019 (DE) 102019127658.6

(51) Int. Cl. C23C 2/00; B30B 3/00; B30B 5/04; B30B 15/06; C23C 2/26; C23C 2/04

(52) U.S. Cl. CPC C23C 2/0064; B30B 3/005; B30B 5/04; B30B 15/062; C23C 2/265; C23C 2/04

(57) ABSTRACT

A method for producing a pressing tool for producing a workpiece, the pressing tool may include a pressing surface having a structure of protrusions and recesses, the method may include applying a mask for covering regions, applying a metal layer to the regions not covered by the mask while adding mineral particles, and/or repeating the foregoing steps until the pressing surface with the structure of the protrusions and recesses is formed by repeated, layered application of masks and metal layers while adding mineral particles. The pressing surface may have regions of different degrees of gloss and/or metal of at least two metal layers may be different in order to obtain the regions of different degrees of gloss.

### CROSS-REFERENCE TO RELATED APPLICATIONS

This application is a U.S. National phase based on, and claiming priority to, PCT/EP2020/078581, filed on Oct. 12, 2020, entitled “PRESSING TOOL AND METHOD FOR PRODUCING A PRESSING TOOL” which is based on and claims priority to German Patent Application No. DE102019127658.6, filed on Oct. 15, 2019, each of which are hereby incorporated by reference in their entirety.

### BACKGROUND

The disclosure relates to a pressing tool and a method for producing a pressing tool. The pressing tool comprises a structured pressing surface.

Pressing tools, for example in the form of pressing plates, endless belts or embossing rollers are, for example, used in the woodworking industry, for example to produce furniture, laminates or panels, i.e. in general workpieces. The workpieces are pressed with the pressing surface of the pressing tool, such that the workpieces obtain surfaces corresponding to the pressing surface.

WO 2015/036070 A1 discloses a pressing tool having a structured pressing surface, which is produced by means of metal layers located on top of one another. For this purpose, at least a one-time application of a mask is performed in order to cover partial regions and at least a one-time application of a metal layer to the non-covered regions is performed in order to construct the structured pressing surface consisting of protrusions and recesses. These two method steps are repeated until a desired structural depth of the structured pressing surface has been reached. The structured pressing surface may subsequently be provided with a hard chromium layer.

WO 2008/120058 A1 discloses a pressing tool, the pressing surface of which is formed by a layer, which consists of a metal matrix with mineral or ceramic particles embedded therein.

CH711268 B1 discloses a plating processing method for a gripping surface of a gripping tool. In this process, multiple diamond grains having a uniform first grain diameter are temporarily and evenly fixed, such that points of the diamond grains can be aligned. The diamond grains are attached to a gripping surface by applying metal containing nickel.

WO2014202041 A1 discloses a method for producing a surface structure of a pressing tool for pressing material plates, plastic films, separating films, PVC surfaces, LVT (luxury vinyl tiles), check cards, passports, credit cards or plastic cards.

An object of the disclosure is to provide an improved pressing tool with a structured pressing surface.

Another object of the disclosure is achieved by a method for the non-etching production of a pressing tool provided for producing a workpiece, which pressing tool has one or more pressing surface having a structure of protrusions and recesses, comprising the following method steps:
a) applying a mask for covering regions,
b) applying a metal layer to the regions not covered by the mask while adding mineral particles, and
c) repeating steps a) and b) until the pressing surface with the structure of the protrusions and recesses is formed by repeated layered application of masks and metal layers while adding mineral particles.

The object of the disclosure is also achieved by a pressing tool, which is provided for producing a workpiece, comprising a pressing surface having a structure of protrusions and recesses and multiple metal layers superimposed in layers, in which mineral particles are embedded and which form the pressing surface.

The pressing tool according to the disclosure is particularly produced using the method according to the disclosure.

The pressing surface may possibly be cleaned to remove residues of the masks.

The pressing tool according to the disclosure is, for example, an endless belt, an embossing roller or, preferably, a pressing plate and comprises the pressing surface. This comprises a structure of protrusions and recesses, thus being a structured pressing surface. Thereby, the workpiece produced with the pressing tool receives a structured surface corresponding to the structure of the pressing surface.

The workpiece is, for example, a material board. It comprises, for example, a carrier, for example an MDF board or a chipboard, which is pressed with a resin- or plastic-impregnated substrate, for example paper by means of the pressing tool. The material board may also be a so-called luxury vinyl tile (LVT).

The pressing tool according to the disclosure comprises the multiple metal layers superimposed in layers, thus particularly multiple metal layers lying on top of one another.

Preferably, the metal layers are chromium-free metal layers, for example nickel layers. This increases the environmental friendliness of the production.

According to the method according to the disclosure, the pressing tool is produced by repeated application of a mask in order to cover regions and in order to subsequently provide the regions not covered by the mask with a metal layer. This is repeated until the pressing surface with its structure has been formed. Thus, a construction of the pressing tool that is structured in a layered manner due to the metal layers, which are in particular partial metal layers, and thus the pressing surface with its structure of protrusions and recesses is formed. The pressing surface is thus not formed by an additional hard chromium layer, the production of which is relatively environmentally harmful.

During the production of the workpiece, the pressing surface is in contact with the workpiece and is therefore exposed to wear. In order to increase the wear resistance of the metal layers and thus the wear resistance of the pressing surface despite dispensing with the full-surface hard chromium layer, the mineral particles are embedded in the individual metal layers. Thereby, it is possible to not coat the pressing surface of the pressing tool with a full-surface hard layer, for example of hard chromium, whereby the efforts of production of the pressing surface are reduced.

In order to increase the wear resistance of the pressing surface, the mineral particles are thus embedded in the metal layers of the pressing tool and/or the metal layers are applied in layers while adding the metal layers.

Thus, in the method according to the disclosure, a full-surface coating of the pressing surface with a hard layer, for example of hard chromium, and/or a full-surface application of a hard layer, for example of hard chromium, to the pressing surface is dispensed with. By dispensing with the hard chromium layer, the environmental friendliness of the production of the pressing tool is also increased.

The metal layers may preferably be tempered, whereby, in the case of nickel layers as metal layers, a hardness of at least 1100 HV can result. This hardness is even greater than the hardness of the hard chromium layer of conventional pressing tools.

The production by means of the layered application of the metal layers is carried out using a galvanic or chemical method, in particular without etching. Thus, the production of the pressing plate is relatively environmentally friendly.

If the metal layers are applied while adding the mineral particles using a galvanic method, the metal layers with the mineral particles embedded therein are dispersion layers.

Minerals are, in particular, mostly inorganic, homogeneous, mostly crystalline substances occurring in the earth's crust. The plurality of the minerals known today and recognized as distinct by the International Mineralogical Association are inorganic.

The mineral particles of the metal layers in particular have a Mohs hardness of at least 8.

The mineral particles preferably have a size in the nanometer or micrometer range. Thus, the mineral particles can be embedded in the metal layers relatively homogeneously, whereby the pressing tool obtains a relatively homogeneous wear resistance across its entire pressing surface. The size of the individual mineral particles may be different or essentially the same.

The mineral particles preferably have a volume share of at least 50% with regard to the volume of the relevant metal layer with mineral particles embedded therein. Due to the size, the volume share, and the type of the minerals of the mineral particles, the desired degree of hardness and/or the wear resistance of the metal layers can be adjusted.

In particular, the mineral particles are diamond particles. The diamond particles are in particular industrial diamond particles, i.e. the diamond particles and/or the mineral particles in general can be produced artificially. However, in particular the minerals silicon carbide, boron nitride, boron carbide, aluminum oxide, and titanium oxide may also be used as mineral particles.

The mineral particles are formed, for example as a mineral powder, in particular a diamond powder and preferably as an industrial diamond powder.

According to a preferred embodiment of the method according to the disclosure, the pressing surface undergoes treatment after step c). This treatment may comprise a mechanical treatment and/or a galvanic and/or a chemical treatment of the pressing surface and/or the treatment may be carried out with the aid of a laser. The treatment of the pressing surface may also be a thermal treatment, such as tempering.

The pressing tool comprises the multiple metal layers applied on top of one another with the mineral particles embedded therein. As the metal layers were applied only to the regions not covered by the corresponding masks, these metal layers are partial metal layers and therefore not full-surface metal layers.

The pressing surface of the pressing tool may have different degrees of gloss, which are in particular predetermined degrees of gloss, in different regions. This means that the pressing surface may have regions of different degrees of gloss, in particular regions with predetermined different degrees of gloss.

Preferably, it may be provided that the metal of at least two metal layers is different, in order to obtain the regions of different degrees of gloss. This easily enables the realization of the regions of different degrees of gloss.

In order to obtain the different degrees of gloss, it may also be provided that the multilayer composite obtained by then is treated prior to the application of the last and/or top metal layer. This treatment may comprise a mechanical treatment and/or a galvanic and/or a chemical treatment of the pressing surface and/or the treatment may be carried out with the aid of a laser.

The application of the masks may preferably be carried out dependent on image data, which is assigned to the structure of the pressing surface.

The pressing tool may be produced particularly dependent on image data assigned to the structure of the structured pressing surface. Preferably, the masks are applied dependent on this image data, which is assigned to the structure of the structure pressing surface.

The pressing surface is, in particular, assigned to a natural material, such as wood or stone. In order to obtain the structure of the pressing surface, it can be provided that a model, for example a piece of wood or a stone is scanned to obtain image data. This image data includes, in particular, information about the structure that the pressing surface is to have.

The image data obtained by scanning can, for example, be edited manually to obtain the image data assigned to the structure of the pressing surface.

The masks are applied for example by means of a print head. If the pressing tool is a pressing plate, the application of the mask preferably takes place with such a print head, which is arranged above the pressing surface to be produced and which is moved during the application in a plane parallel to the pressing surface. As the multilayer composite of the currently applied metal layers becomes higher, it is preferably provided that the print head is moved in a direction orthogonal to the pressing surface, such that the distance between the currently applied mask and the print head is kept constant. Due to the constant distance, the currently applied mask can be applied in an improved manner using the print head.

### BRIEF DESCRIPTION OF THE DRAWINGS

Exemplary embodiments of the disclosure are shown in the enclosed schematic figures by way of example. These show:

FIG. 1 a pressing plate with a pressing surface in a perspective representation;

FIG. 2 a cutout from a lateral view of the pressing plate in a sectional representation;

FIG. 3 an intermediate state of the pressing plate during its production; and

FIG. 4 a device for applying masks.

### DETAILED DESCRIPTION

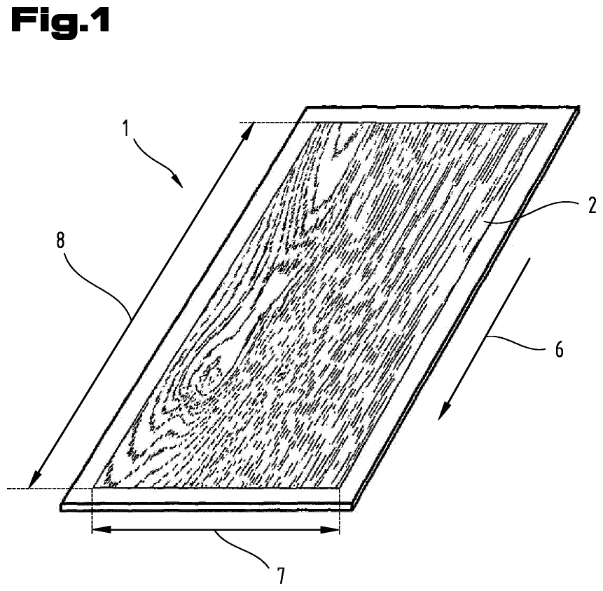

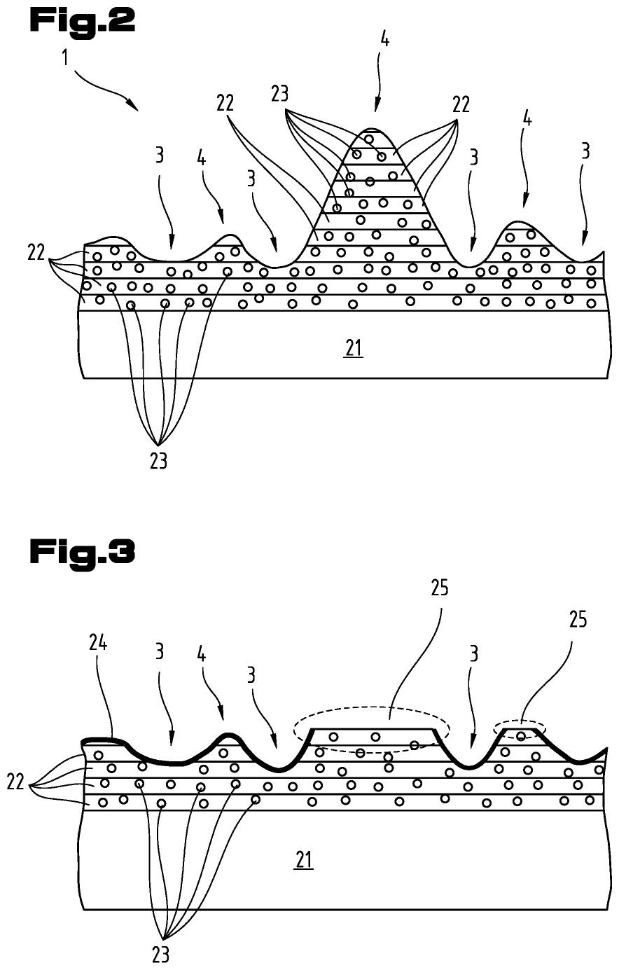

FIG. 1 shows, in a perspective representation, a pressing plate 1 with a pressing surface 2 as an example of a pressing tool. FIG. 2 shows a cutout of a lateral view of the pressing plate 1 in a sectional representation, and FIG. 3 shows an intermediate state of the pressing plate 1 during its production.

The pressing surface 2 comprises a structure of recesses 3 and protrusions 4 and is assigned, for example, to a wood grain.

In case of the present exemplary embodiment, the pressing surface 2 is rectangular and has a transverse extension 7 and a longitudinal extension 8. Moreover, the structure of the structured pressing surface 2 extends along a preferential direction 6, which in the case of the present exemplary embodiment extends along the longitudinal extension 8.

By the pressing plate 1, a workpiece, e.g. a pressing plate, for example a laminate, can be produced by pressing. After pressing, the workpiece has a surface structured correspondingly to the structure of the pressing surface 2.

In the case of the present exemplary embodiment, the pressing plate 1 comprises a base carrier 21 of steel and multiple metal layers 22 arranged on top of one another and/or superimposed in layers, wherein each of the metal layers 22 has mineral particles 23 embedded therein and is arranged on the base carrier 21. The metal layers 22 are particularly nickel layers. The metal layers 22 with the mineral particles 23 embedded therein form the pressing surface 2.

The mineral particles 23 have, in particular, a Mohs hardness of at least 8 and a size in the nanometer or micrometer range. The volume share of the mineral particles 23 is preferably at least 50% with regard to the volume of the metal layer 22 with the mineral particles 23 embedded therein.

In the case of the present exemplary embodiment, the mineral particles 23 are industrial diamond particles.

In the case of the present exemplary embodiment, the metal layers 22 were produced by means of a chemical or galvanic method.

The pressing plate 1 was produced without etching in that a mask 24 was applied to cover regions, a metal layer 22 was applied to the regions 25 not covered by the mask 24 while adding the mineral particles 23, and this was repeated until the pressing surface 2 with the structure of protrusions 4 and recesses 3 was formed by means of repeated, layered application of masks 24 and metal layers 22 while adding mineral particles 23.

FIG. 3 shows in particular a cutout from a lateral view in a sectional representation of an intermediate state of the pressing plate 1 during its production. FIG. 3 shows in particular a multilayer composite of multiple metal layers 22 arranged on top of one another and/or superimposed in layers, with mineral particles 23 embedded therein, to which a mask 24 is applied in order to cover regions. In the subsequent step, a further metal layer 22 is applied to this multilayer composite while adding mineral particles 23. This is repeated, as already described, until the pressing surface 2 with the structure of protrusions 4 and recesses 3 is formed. The metal layers 22 with the mineral particles 23 embedded therein are partial metal layers.

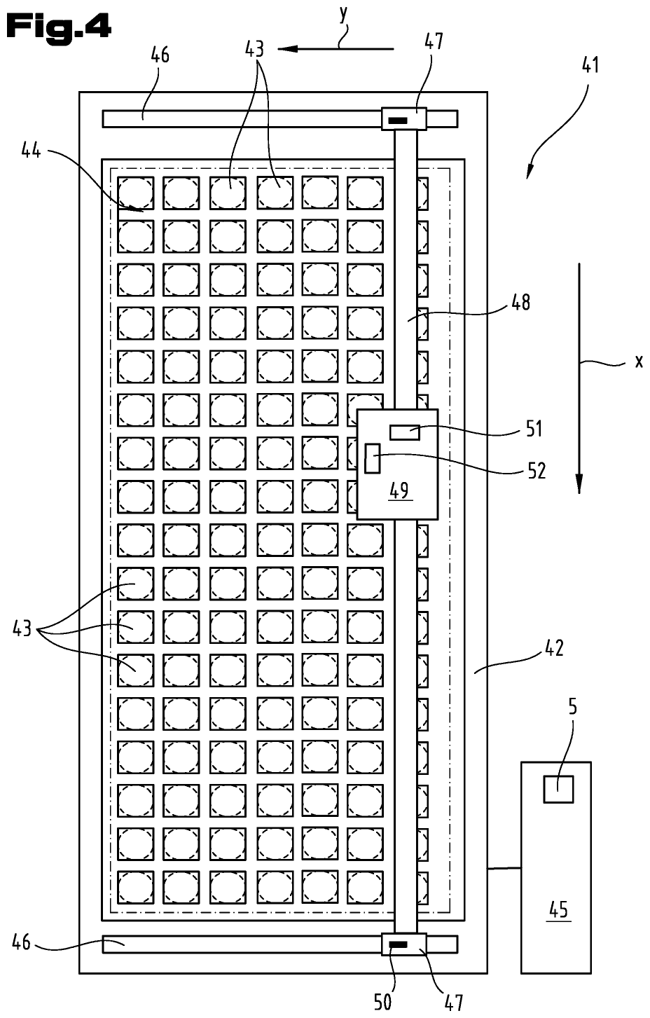

FIG. 4 shows a top view of an example of a device 41 for applying the masks 24 to the multilayer composite. In the case of the present exemplary embodiment, this device 41 comprises a support table 42 which has a support surface 44 made of multiple individual planar surfaces 43. To produce the pressing plate 1, the base carrier 21 is first placed on the support surface 42 such that its side, on which the pressing surface 2 is to be built, faces away from the support surface 44.

The support surface 44 is, in particular, rectangular and has dimensions adapted to the dimensions of the pressing plate 1.

In the case of the present exemplary embodiment, the device 41 comprises an electronic controller 45 which controls the operation of the device 41.

In the case of the present exemplary embodiment, suction orifices, which draw the pressing plate 1 and/or the base carrier 21 onto the planar surfaces 43 by means of a vacuum pump of the device 41, said vacuum pump not being shown and controlled by the electronic controller 45, are formed in the planar surfaces 43, whereby the pressing plate 1 and/or its base carrier is fixed on the support surface 44.

The device 41 is embodied such that the pressing plate 1 and/or its base carrier 21 fixed on the support surface 44 is arranged between the support surface 44 and the print head 49.

Thus, it is possible to move the print head 49 to the desired position relative to the base carrier 21, controlled by the electronic controller 45. In particular, it is provided that the print head 49 is moved in the direction orthogonal to the pressing surface 2 by means of the electrical drive 52, such that the distance between the currently applied mask 24 and the print head 49 is kept constant.

In the case of the present exemplary embodiment, the pressing surface 2 is assigned to a wood surface. In order to obtain the structure of the pressing surface 2, it can be provided that a model, for example a wood surface is scanned to obtain image data. This image data includes, in particular, information about the structure that the pressing surface 2 is to have. The image data obtained by scanning can, for example, be edited manually to obtain image data 5 assigned to the structure of the pressing surface 2.

In the case of the present exemplary embodiment, the application of the masks 24 and of the metal layers 22 is carried out dependent on the image data 5 assigned to the structure of the pressing surface 2.

In the case of the present exemplary embodiment, the image data 5 assigned to the structure of the pressing surface 2 is stored in the electronic controller 45. The electronic controller is, in particular, configured to control the electrical drive 50, the further electrical drive 51 and print head 49 dependent on the image data 5.

In the case of the present exemplary embodiment, the pressing surface 2 is possibly cleaned in order to remove residues of the masks 24, for example.

The pressing surface 2 in particular has regions with the different, preferably predetermined degrees of gloss. In order to achieve this, it may be provided that the metal of at least two metal layers 22 is different. It may also be provided that the multilayer composite of metal layers 22 is treated prior to the application of the last and/or top metal layer. This treatment may comprise a mechanical treatment, for example polishing or matting, and/or a galvanic and/or a chemical treatment of the pressing surface 2 and/or the treatment may be carried out with the aid of a laser.

The pressing surface 2 can still be treated. This treatment may comprise a mechanical treatment, for example polishing, and/or a galvanic and/or a chemical treatment of the pressing surface 2 and/or the treatment may be carried out with the aid of a laser. The treatment of the pressing surface 2 may also be a thermal treatment, such as tempering of the pressing surface 2. Thus, the pressing surface 2 may have a hardness of, for example, at least 1100 HV, particularly in the case of nickel layers.

1. A method for producing a pressing tool provided for producing a workpiece, the pressing tool includes a pressing surface having a structure of protrusions and recesses, the method comprising:
a) applying a mask for covering regions;
b) applying a metal layer to the regions not covered by the mask while adding mineral particles; and
c) repeating steps a) and b) until the pressing surface with the structure of the protrusions and recesses is formed by repeated, layered application of masks and metal layers while adding mineral particles;
wherein the pressing surface has regions of different degrees of gloss; and
wherein metal of at least two metal layers is different in order to obtain the regions of different degrees of gloss.

2. The method according to claim 1, further comprising applying the mask dependent on image data assigned to the structure of the pressing surface.

3. The method according to claim 1, further comprising treating the pressing surface after step c).

4. The method according to claim 1, further comprising treating the pressing surface after step c) by means of polishing or matting of the pressing surface, and/or by means of a chemical or galvanic method and/or by means of a laser.

5. The method according to claim 1, wherein the regions of different degrees of gloss are regions of predetermined different degrees of gloss.

6. The method according to claim 5, wherein a multilayer composite of metal layers is treated prior to the application of a top metal layer.

7. The method according to claim 1, further comprising tempering of the pressing surface after step c), so that the pressing surface obtains a hardness of at least 1100 HV.

8. The method according to claim 1, wherein the metal layers are one of chromium-free metal layers, nickel layers, and/or the method is a non-etching method, and/or the metal layers are applied by means of a chemical or galvanic method.

9. The method according to claim 1, wherein the mineral particles have a Mohs hardness of at least 8 and/or are diamond particles and/or have a size in a nanometer or micrometer range and/or have a volume share of at least 50% with regard to the volume of a relevant metal layer with mineral particles embedded therein.

10. The method according to claim 1, in which wherein the pressing tool is a pressing plate, further comprising:
applying the masks using a print head, which is arranged above the pressing surface to be produced and which is moved during the application of the masks in a plane parallel to the pressing surface, and moving the print head in a direction orthogonal to the pressing surface, such that a distance between the currently applied mask and the print head is kept constant.

11. A pressing tool for producing a workpiece, comprising:
a pressing surface having a structure of protrusions and recesses and multiple metal layers superimposed in layers;
wherein metal layers and mineral particles are embedded and which form the pressing surface.
